(19) United States
(12) Patent Application Publication
(10) Pub. No.: US 2012/0008095 A1
(43) Pub. Date: Jan. 12, 2012

(54) PROJECTION DISPLAY DEVICE AND SPEAKER DEVICE

(75) Inventors: Keiichi Sakashita, Hirakata-city (JP); Taichi Yoshimura, Osaka-city (JP); Toshimasa Kanbara, Kashiwada-city (JP); Hiroshi Hayashi, Hirakata-city (JP)

(73) Assignee: SANYO Electric Co., Ltd., Moriguchi-city (JP)

(21) Appl. No.: 13/167,067

(22) Filed: Jun. 23, 2011

(30) Foreign Application Priority Data
Jul. 6, 2010 (JP) 2010-154344

(51) Int. Cl. G03B 31/00; H04R 1/02

(52) U.S. Cl. 353/15; 381/332

(57) ABSTRACT

A projection display device includes: a light source; a light modulation portion which modulates light from the light source in accordance with an image signal; a projection portion which projects the light modulated by the light modulation portion onto a projection plane; a speaker device which outputs a sound in accordance with an audio signal; and a main body cabinet in which the light source, the light modulation portion, the projection portion, and the speaker device are disposed. The speaker device includes a speaker and a speaker box storing the speaker. The speaker box includes: a front panel to which the speaker is attached; an inner box which covers the speaker attached to the front panel from behind; and an outer box which covers the periphery of the inner box and is attached to the main body cabinet. There is a space created between the two boxes.

This application claims priority under 35 U.S.C. Section 119 of Japanese Patent Application No. 2010-154344 filed Jul. 6, 2010, entitled “PROJECTION DISPLAY DEVICE AND SPEAKER DEVICE”. The disclosure of the above application is incorporated herein by reference.

### BACKGROUND OF THE INVENTION

1. Field of the Invention

The present invention relates to projection display devices which modulate light from a light source and enlarge and project the same onto a projection plane, and to speaker devices which are built into electrical devices such as projection display devices.

2. Disclosure of Related Art

Conventionally, some of projection display devices such as liquid crystal projectors (hereinafter, called “projectors”) include speaker devices. So-called business-purpose projectors for use at office and school are commonly provided with built-in speaker devices.

In general, speaker devices are configured to have a speaker stored in a speaker box. The speaker box storing the speaker is disposed within a projector at a predetermined position.

High-power speaker devices are needed in situations that require high power and high sound quality such as showing a movie. However, as the speaker becomes larger in power, the speaker box vibrates and its vibrations are likely to be transferred to peripheral components. When the vibrations are transferred to the surroundings of the speaker box, noise such as chatter may be generated.

### SUMMARY OF THE INVENTION

A projection display device in a first aspect of the present invention includes: a light source; a light modulation portion which modulates light from the light source in accordance with an image signal; a projection portion which projects the light modulated by the light modulation portion onto a projection plane; a speaker device which outputs a sound in accordance with an audio signal; and a main body cabinet in which the light source, the light modulation portion, the projection portion, and the speaker device are disposed. In this arrangement, the speaker device includes a speaker and a speaker box storing the speaker. In addition, the speaker box includes: a front panel to which the speaker is attached; an inner box which covers the speaker attached to the front panel from behind; and an outer box which covers the periphery of the inner box and is attached to the main body cabinet. In addition, there is a space created between the inner box and the outer box.

A speaker device in a second aspect of the present invention includes a speaker and a speaker box storing the speaker. In this arrangement, the speaker box includes a front panel to which the speaker is attached, an inner box which covers the speaker attached to the front panel from behind, and an outer box which covers the periphery of the inner box. In addition, there is a space created between the inner box and the outer box.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams (perspective views) showing an external construction of a projector embodying the invention.

FIG. 2 is a diagram (bottom view) showing an external construction of the projector as the embodiment.

FIG. 3 is a diagram showing an internal structure of the projector as the embodiment.

FIG. 4 is a diagram schematically showing an arrangement of a projection optical unit in the embodiment.

FIGS. 5A to 5C are diagrams for describing a configuration of a speaker unit in the embodiment;

FIGS. 6A and 6B are diagrams for describing a configuration of the speaker unit in the embodiment;

FIG. 7 is a diagram for describing a configuration of the speaker unit in the embodiment;

FIG. 8 is a diagram for describing a configuration of the speaker unit in the embodiment;

FIGS. 9A and 9B are diagrams for describing attachment of the speaker unit to a main body cabinet in the embodiment;

FIGS. 10A and 10B are diagrams showing schematically states of a front panel attached to a rear box in the embodiment; and

FIGS. 11A and 11B are diagrams showing a configuration of a speaker unit in a modification example.

The drawings are provided mainly for describing the present invention, and do not intended to limit the scope of the present invention.

### DESCRIPTION OF PREFERRED EMBODIMENTS

An embodiment of the present invention will be described below with reference to the diagrams.

In this embodiment, a lamp unit 14 corresponds to a “light source” recited in the claims. A light modulation unit 15 corresponds to a “light modulation portion” recited in the claims. A projection optical unit 17 corresponds to a “projection portion” recited in the claims. A speaker unit 19 corresponds to a “speaker device” recited in the claims. First reinforcement ribs 432, second reinforcement ribs 442, a third reinforcement rib 443, fourth reinforcement ribs 994, and fifth reinforcement ribs 445 correspond to a “rib” recited in the claims. Flange portions 997 correspond to an “attachment portion” recited in the claims. Low ribs 446 correspond to a “depressing portion” recited in the claims. However, the foregoing correspondences in description between the claims and this embodiment are mere examples, and are not intended to limit the claims to this embodiment.

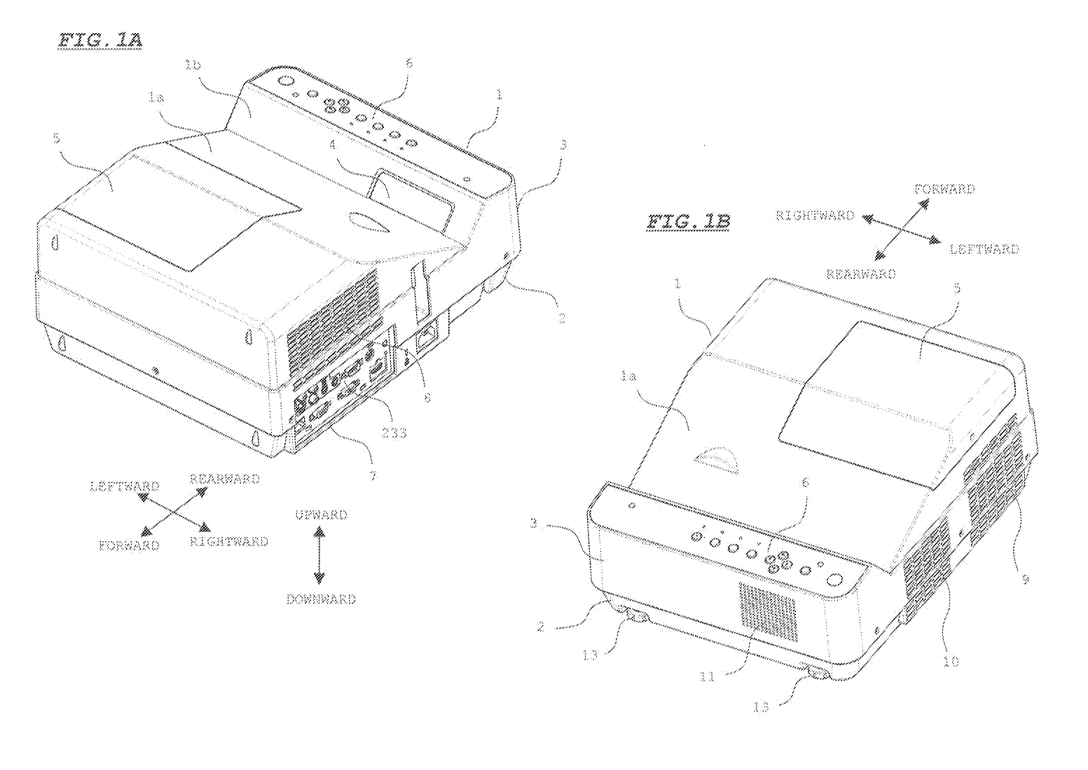

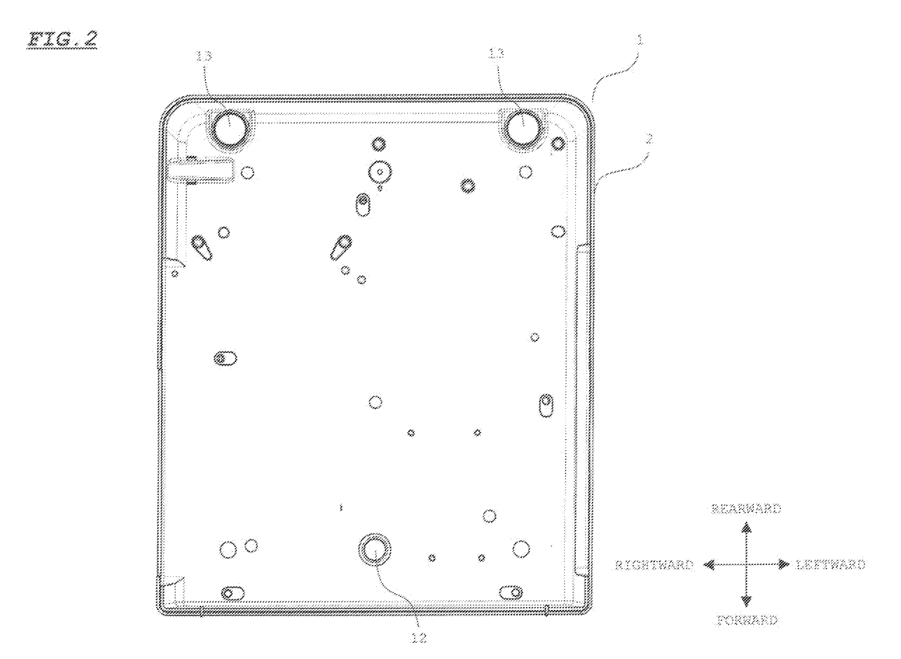

FIGS. 1A, 1B and FIG. 2 are diagrams showing an external construction of a projector embodying the invention. FIG. 1A is a perspective view of the projector when viewed from a front side, and FIG. 1B is a perspective view of the projector when viewed from a rear side. FIG. 2 is a bottom view of the projector. To simplify the description, arrows respectively indicating forward, rearward, leftward, and rightward directions, and arrows each indicating upward and downward directions are depicted in FIGS. 1A, 1B and FIG. 2. Hereinafter, the arrows indicating forward, rearward, leftward, and rightward directions are depicted in the same manner as above in the other drawings, as necessary.

The projector of the embodiment is a so-called short focus projector. Referring to FIGS. 1A and 1B, the projector is provided with a main body cabinet 1 having a substantially rectangular parallelepiped shape. The main body cabinet 1 is constituted of a lower cabinet 2, and an upper cabinet 3 which is placed on the lower cabinet 2 from above.

A top surface of the main body cabinet 1 is formed with a first slope 1a inclined downward and rearward, and a second slope 1b continuing from the first slope 1a and inclined upward and rearward. The second slope 1b faces obliquely upward and forward, and a projection port 4 is formed in the second slope 1b. Image light emitted obliquely upward and forward through the projection port 4 is enlarged and projected onto a screen disposed in front of the projector.

Further, the top surface of the main body cabinet 1 is formed with a lamp cover 5. The top surface of the main body cabinet 1 is formed with a lamp opening for use in exchanging a lamp unit, and a filter opening for use in exchanging a filter disposed in a fan unit for cooling the lamp unit. The lamp cover 5 is a cover for covering the lamp opening and the filter opening. Further, the top surface of the main body cabinet 1 is provided with an operation portion 6 constituted of a plurality of operation keys.

A terminal port portion 7 is formed in a right surface of the main body cabinet 1. A terminal panel 233 having various terminals such as AV terminals is attached to the terminal port portion 7. The terminal panel 233 constitutes a part of a control circuit unit to be described later. Audio Visual (AV) signals such as an image signal and an audio signal are inputted and outputted to and from the projector through the AV terminals. Further, an air inlet 8 is formed in the right surface of the main body cabinet 1 at a position above the terminal port portion 7. The air inlet 8 is constituted of multitudes of slit holes, and external air is drawn into the main body cabinet 1 through the air inlet 8.

A first air outlet 9 is formed in a front portion on a left surface of the main body cabinet 1, and a second air outlet 10 is formed in a middle portion on the left surface of the main body cabinet 1. Each of the first and second air outlets 9, is constituted of multitudes of slit holes, and air inside the main body cabinet 1 is discharged to the outside of the projector through the first and second air outlets 9, 10. Further, a sound output port 11 is formed in a rear surface of the main body cabinet 1. Sounds in accordance with images are outputted through the sound output port 11 at the time of image projection.

Referring to FIG. 2, a fixed leg 12 is disposed in the middle of a front portion on a bottom surface of the main body cabinet 1, and two adjustable legs 13 are disposed at a rear end thereof. By expanding or contracting the two adjustable legs 13 up and down, it is possible to adjust the inclination of the main body cabinet 1 in forward/rearward directions and leftward/rightward directions. Thus, it is possible to adjust the upward/downward position and the leftward/rightward inclination of an image projected on a screen.

The projector of the embodiment may be installed in a suspended state from a ceiling with the main body cabinet 1 being upside down, other than an installation manner that the bottom surface of the main body cabinet 1 is placed on an installation plane such as a desk surface or a floor surface. Further, a front surface of the main body cabinet 1 is a flat surface without the terminal panel 233 and the air inlet 8. Accordingly, it is possible to install the projector of the embodiment in such a manner that the front surface of the main body cabinet 1 is placed on an installation plane. In this case, an image is projected on the installation plane itself.

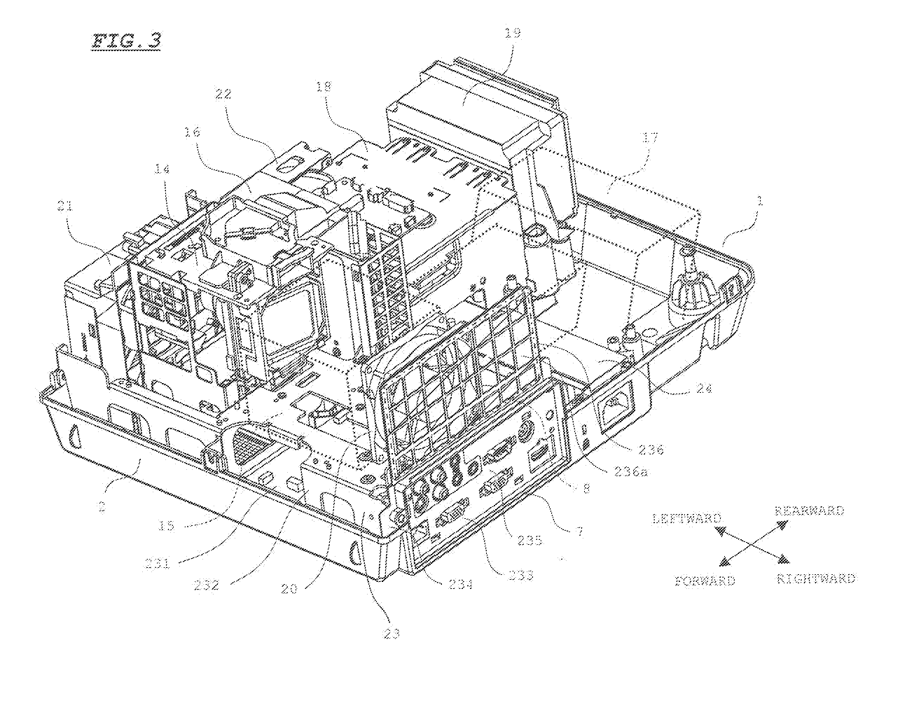

FIG. 3 is a diagram showing an internal structure of the projector. FIG. 3 is a perspective view showing a state that the upper cabinet 3 is detached, when viewed from a front side. To simplify the description, in FIG. 3, an imager unit 15 and a projection optical unit 17 are indicated by the dotted lines. Further, the position of the air inlet 8 is indicated by the one-dotted chain line.

Referring to FIG. 3, a lamp unit 14, and the imager unit 15 for modulating light from the lamp unit 14 to generate image light are disposed on a front portion of the lower cabinet 2.

The lamp unit 14 is constituted of a light source lamp, and a lamp holder for holding the light source lamp; and is configured so as to be detachably attached from above. A fan unit 16 is disposed behind the lamp unit 14. The fan unit 16 supplies external air (cooling air) drawn through the air inlet 8 to the light source lamp to cool the light source lamp. The lamp holder is formed with an air duct for guiding the cooling air from the fan unit 16 to the light source lamp.

The imager unit 15 includes a color wheel and a Digital Micromiror Device (DMD). The color wheel separates white light from the light source lamp into light of respective colors such as red, green, blue in a time-sharing manner. The DMD modulates the light of the respective colors emitted from the color wheel based on an image signal.

The projection optical unit 17 is disposed at a rear position of the imager unit 15. The projection optical unit 17 enlarges image light generated by the imager unit 15, and projects the enlarged image light onto a projection plane such as a screen.

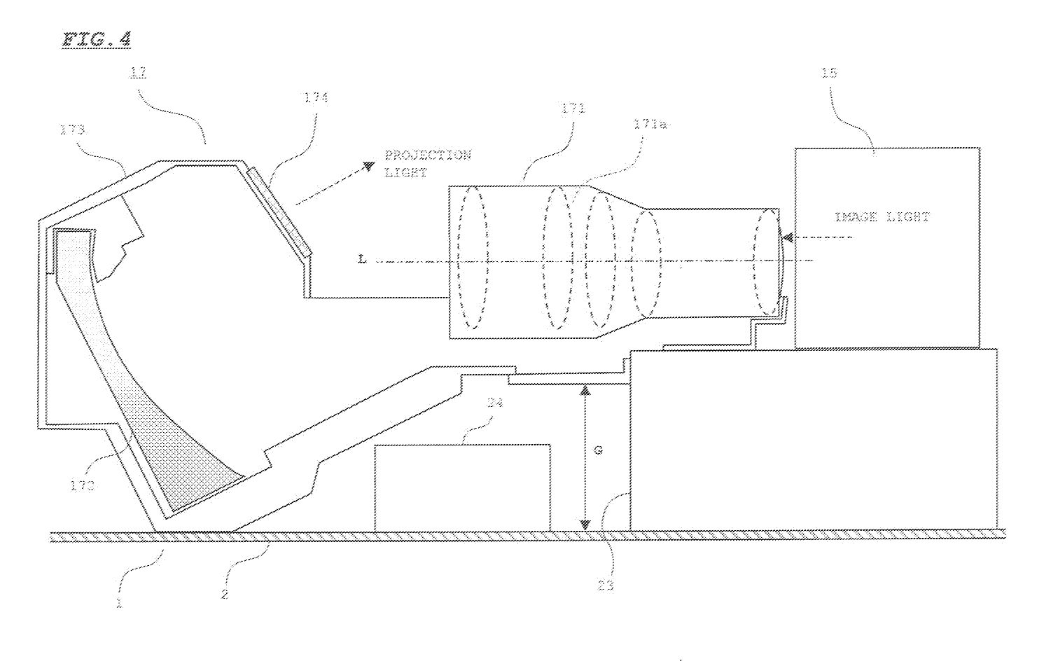

FIG. 4 is a diagram schematically showing an arrangement of the projection optical unit 17. In FIG. 4, the imager unit 15, a control circuit unit 23, and a noise filter unit 24 are schematically shown, in addition to the projection optical unit 17.

The projection optical unit 17 is constituted of a projection lens unit 171, a reflection mirror 172, and a housing 173 for housing the projection lens unit 171 and the reflection mirror 172. The projection lens unit 171 has a plurality of lenses 171a. The reflection mirror 172 is a curved mirror or a free curved mirror.

As shown in FIG. 4, image light emitted from the imager unit 15 is entered into the projection lens unit 171 at a position shifted from the optical axis L of the projection lens unit 171 in a direction toward the top surface of the main body cabinet 1. The entered image light is provided with a lens action by the projection lens unit 171, and is entered into the reflection mirror 172. Thereafter, the projection angle of the image light is expanded by the reflection mirror 172, and the image light is projected onto a projection plane (screen) via a light ray passage window 174.

As described above, image light is entered into the projection lens unit 171 at a position shifted from the optical axis L of the projection lens unit 171 in a direction toward the top surface of the main body cabinet 1. In view of this, the reflection mirror 172 is disposed at a position shifted from the optical axis L of the projection lens unit 171 toward the bottom surface of the main body cabinet 1. Here, the reflection mirror 172 has a reflection surface larger than the lens surface of each lens 171a constituting the projection lens unit 171. Accordingly, the shift amount of the reflection mirror 172 with respect to the optical axis L of the projection lens unit 171 is relatively large. Consequently, there is defined a relatively large space G between a lower surface of the projection lens unit 171 and the bottom surface of the main body cabinet 1 (lower cabinet 2). The space G is defined from the position where the projection lens unit 171 is disposed to the position where the imager unit 15 is disposed.

Referring back to FIG. 3, a power source unit 18 is disposed behind the fan unit 16. The power source unit 18 is provided with a power source circuit to supply electric power to each electric component of the projector. A speaker unit 19 is disposed behind the power source unit 18. Sounds outputted through the speaker unit 19 are released to the outside through the sound output port 11.

A DMD cooling fan 20 is disposed on the right of the imager 15. The DMD cooling fan 20 supplies external air drawn through the air inlet 8 to the imager unit 15 so as to cool the DMD. The DMD is sealably disposed in the imager unit 1S, so that the DMD is kept from being directly contacted with the supplied external air.

A first exhaust unit 21 is disposed on the left of the lamp unit 14. The first exhaust unit 21 discharges air that has cooled the light source lamp to the outside through the first air outlet 9. The first exhaust unit 21 also discharges air that has cooled the DMD to the outside through the first air outlet 9.

A second exhaust unit 22 is disposed on the left of the power source unit 18. The second exhaust unit 22 discharges air that has been warmed in the inside of the power source unit 18 to the outside through the second air outlet 10. By flowing air from the inside of the power source unit 19 to the second exhaust unit 22, fresh external air is supplied into the power source unit 18 through the air inlet 8.

As shown in FIG. 3 and FIG. 4, in the projector of the embodiment, the control circuit unit 23 and the noise filter unit 24 are disposed in the space G defined below the projection lens unit 171 and the imager unit 15.

The noise filter unit 24 is provided with a circuit board mounted with a noise filter and a fuse thereon, and supplies electric power inputted from a commercial AC power source to the power source unit 18 after noise removal.

The control circuit unit 23 includes a control circuit board 231, a holder 232 for holding the control circuit board 231, the terminal panel 233, and a fixing board 234 for fixing the terminal panel 233.

A control circuit for controlling various driving components such as a light source lamp and a DMD is mounted on the control circuit board 231. Further, various terminals 235 are mounted on the control circuit board 231.

The terminal panel 233 is formed with various openings of the shapes in accordance with the shapes of the terminals 235. The terminals 235 are exposed to the outside through the openings. Although not illustrated, the fixing board 234 is formed with openings through which the terminals 235 pass, as well as the terminal panel 233.

The fixing board 234 is made of a metal material, and a shielding portion 236 is formed on an upper portion thereof. The shielding portion 236 is formed with multitudes of openings 236a, and a metal mesh (not shown) is attached to each of the openings 236a. The shielding portion 236 is disposed on the inside of the air inlet 8 to block electromagnetic wave from leaking to the outside through the air inlet 8. External air drawn through the air inlet 8 is supplied to the inside of the main body cabinet 1 through the openings 236a.

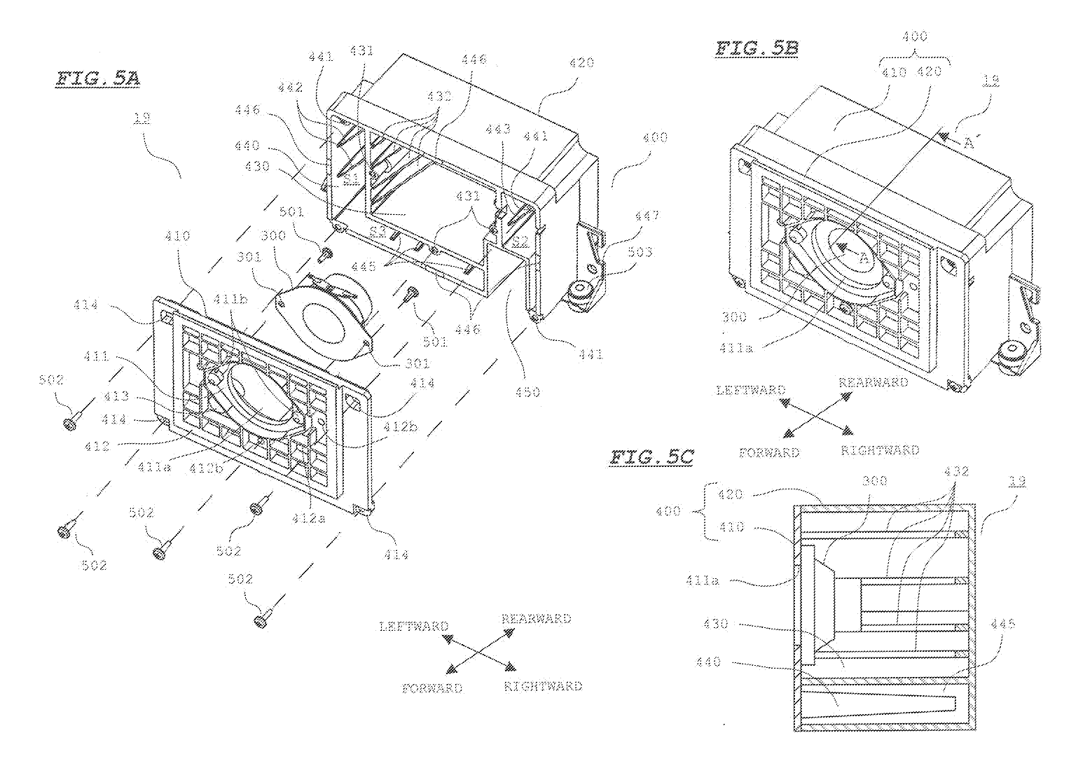

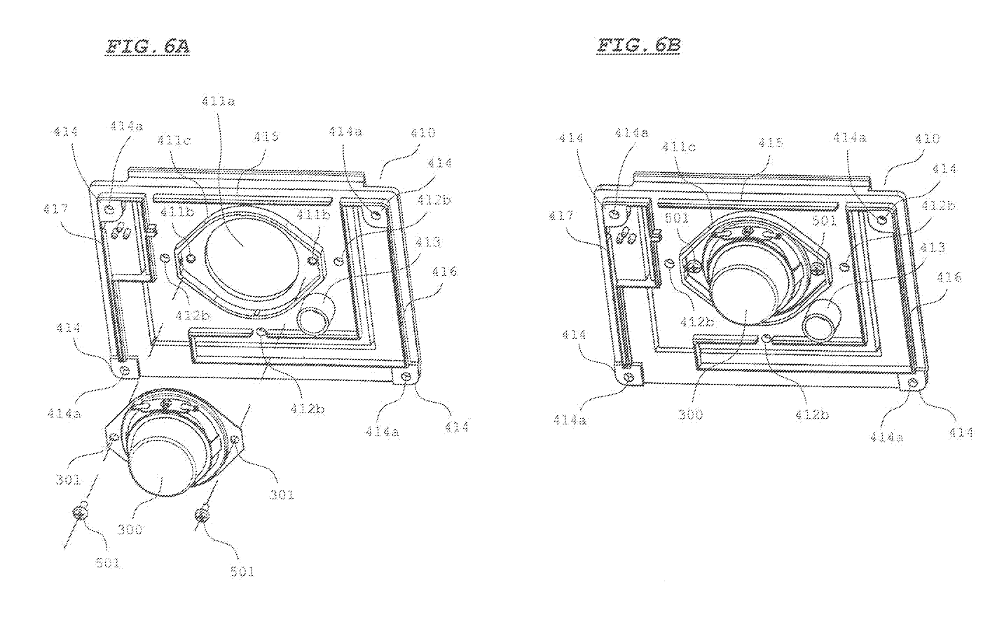

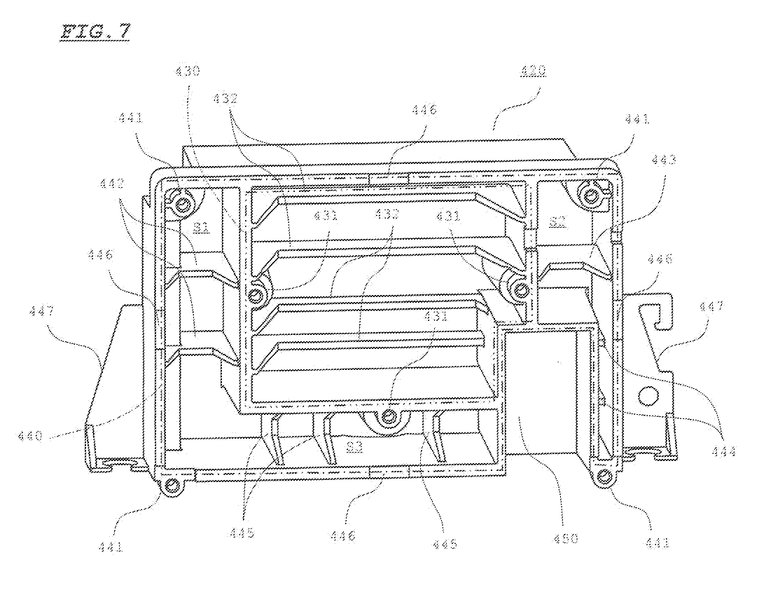

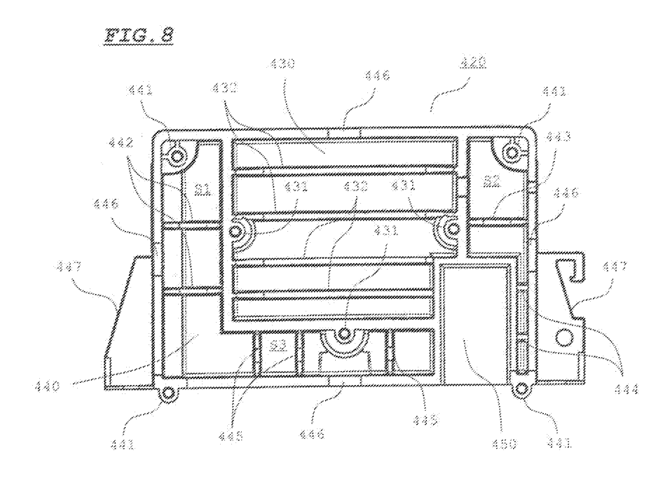

FIGS. 5A to 8 are diagrams for describing a configuration of the speaker unit 19. FIG. 5A is an exploded perspective view of the speaker unit 19, and FIG. 5B is an assembled perspective view of the speaker unit 19. FIG. 5C is a diagram showing schematically a cross-section of FIG. 5B taken along a line A-A′. FIG. 6A is a rear view of the front panel 410 with the speaker 300 not attached, and FIG. 6B is a rear view of the front panel 410 with the speaker 300 attached. FIG. 7 is a perspective view of the rear box 420 seen from diagonally above, and FIG. 8 is a front view of the rear box 420.

Referring to these diagrams, a configuration of the speaker unit 19 will be described below in detail.

The speaker unit 19 is constituted by a speaker 300 and a speaker box 400 storing the speaker 300.

The speaker 300, having a power of 10 W, for example, is a relatively high-power speaker among speakers built into projectors.

The speaker box 400 is made of a resin material and is constituted by the front panel 410 and the rear box 420. The rear box 420 is open at a front side to which the front panel 410 with the speaker 300 is attached.

The front panel 410 has a square shape as shown in FIGS. 5A to 5C, 6A, and 6B. The front panel 410 has at a center thereof a panel attachment portion 411. The panel attachment portion 411 has a circular opening 411a. In addition, the panel attachment portion 411 has attachment bosses 411b on right and left sides of the opening 411a. Further, the panel attachment portion 411 has on a back surface thereof a frame portion 411c adapted to the front side shape of the speaker 300. The speaker 300 is fitted into the frame portion 411c as shown in FIG. 6B. At that time, insertion holes 301 formed on both ends of the speaker 300 are aligned with the attachment bosses 411b. Screws 501 are inserted into the insertion holes 301 and tightened at the attachment bosses 411b. Accordingly, the speaker 300 is fixed to the panel attachment portion 411.

The front panel 410 has on a front surface thereof a panel reinforcement portion 912 formed around the panel attachment portion 411. The panel reinforcement portion 412 is constituted by a reinforcement rib 912a formed in a reticular pattern. The panel reinforcement portion 412 enhances the front panel 910 in stiffness properties. This suppresses vibration of the front panel 410 under operation of the speaker 300.

In addition, the front panel 910 has a cylindrical duct 413 which penetrates through the panel and projects rearward.

Further, the front panel 910 has attachment concaves 914 depressed rearward at four corners thereof. These attachment concaves 414 have insertion holes 414a. The front panel 410 also has three insertion holes 412b within the panel reinforcement portion 412.

Moreover, the front panel 410 has three guide ribs 415, 416, and 417 on the back surface thereof.

As shown in FIGS. 5A to 5C, 7, and 8, the rear box 420 is constituted by an inner box 430 and an outer box 440 covering the periphery of the inner box 430. The inner box 430 and the outer box 990 are integrally formed and both have an almost cubic shape. The inner box 430 and the outer box 490 have in common top and back walls. There are created spaces S1, S2, and S3 between right side walls, between left side walls, and between bottom walls of the inner box 930 and the outer box 490, respectively.

The rear box 420 has a depressed portion 450 at lower right side. The depressed portion 450 is formed such that, when the speaker unit 19 is attached to the main body cabinet 1, a shaft of an adjustment leg 13 projecting upward from a bottom surface of the main body cabinet 1 can escape to the depressed portion 950. However, the depressed portion 950 is not needed unless any other member such as the adjustment leg 13 or the like interferes with the speaker unit 19. In this case, the inner box 430 is identical in shape at right and left sides, and the outer box 990 is identical in shape at right and left sides.

The inner box 430 has attachment bosses 431 on inner surfaces of the right and left side walls and an outer surface of a bottom wall. In addition, the inner box 430 has four first reinforcement ribs 432 on an inner wall surface. The first reinforcement ribs 932 are formed at appropriate vertical intervals so as to straddle the right and left side walls and the back wall.

The outer box 440 has attachment bosses 441 at four corners. In addition, two second reinforcement ribs 442, one third reinforcement rib 443, two fourth reinforcement ribs 444, and three fifth reinforcement ribs 445 are formed on an inner wall surface of the outer box 940 and an outer wall surface of the inner box 930.

The second reinforcement ribs 492 are formed at appropriate vertical intervals so as to straddle the left side wall and back wall of the outer box 990 and the left side wall of the inner box 430. The third reinforcement rib 443 is formed so as to straddle the right side wall and back wall of the outer box 990 and the right side wall of the inner box 430. The fourth reinforcement ribs 444 are formed at appropriate vertical intervals so as to straddle the right side wall and back wall of the outer box 990 and the right side wall of the depressed portion 950. The fifth reinforcement ribs 445 are formed at appropriate transverse intervals so as to straddle the bottom wall and back wall of the outer box 990 and the bottom wall of the inner box 930.

The first reinforcement ribs 932, the second reinforcement ribs 492, and the third reinforcement rib 443 become each gradually lower from rear side to front side at right and left portions. In addition, the fifth reinforcement ribs 445 become gradually lower from rear side to front side at upper and lower portions. Accordingly, at formation of the rear box 920, a resin material flows favorably and the molded rear box 420 can be smoothly pulled out of a metal mold.

The outer box 440 has at front ends of the top and bottom walls thereof ribs 446 slightly projecting forward at intermediate portions between right and left corners (hereinafter, called “low ribs 446”). Similarly, the outer box 490 has also on right and left side walls thereof low ribs 446 at intermediate portions between upper and lower corners. An amount of projection of the low ribs 446 is about a few tenths of a millimeter.

The outer box 440 has flange portions 997 on outer sides of the right and left side walls and back wall thereof. The flange portions 447 have bushes 503 made of rubber material attached thereto. The flange portion 447 on the back wall of the outer box 440 is not shown in the diagram.

When assembling the speaker unit 19, the speaker 300 is first attached to the back surface of the front panel 410 as shown in FIG. 6B. Then, the front panel 410 is attached to the front surface of the rear box 420 from the front side. At that time, the guide rib 415 on the back surface of the front panel 410 contacts the top wall of the inner box 430 from inside. In addition, the guide rib 416 contacts the walls of the inner box 430 and the outer box 440 forming the spaces S1 and S3 from inside. In addition, the guide rib 417 contacts the walls of the inner box 430 and the outer box 440 forming the space S2 from inside.

When the front panel 410 is attached to the rear box 420, the insertion holes 414a at the four corners of the front panel 410 are aligned with the screw holes of the attachment bosses 441 at the four corners of the outer box 490. In addition, the three insertion holes 412b of the panel reinforcement portion 412 are aligned with the screw holes of the three attachment bosses 431 of the inner box 430. Screws 502 are inserted through the insertion holes 914a and fastened at the attachment bosses 441. In addition, the screw 502 is inserted through, out of the three insertion holes 412b, the insertion hole 412b located at a lower portion of the panel attachment portion 411, and is fastened at the attachment boss 431 corresponding to this insertion hole 412b. Accordingly, the front panel 410 is fixed to the rear box 420. In this embodiment, two insertion holes 412b of the panel attachment portion 411 and corresponding attachment bosses 431 are not used. If firmer fixation is necessary, additional screws may be tightened between these holes and the bosses.

Consequently, the speaker unit 19 is assembled as shown in FIG. 5B. When the speaker unit 19 is assembled, the rear side of the speaker 300 is entirely covered with the inner box 430 as shown in FIG. 5C.

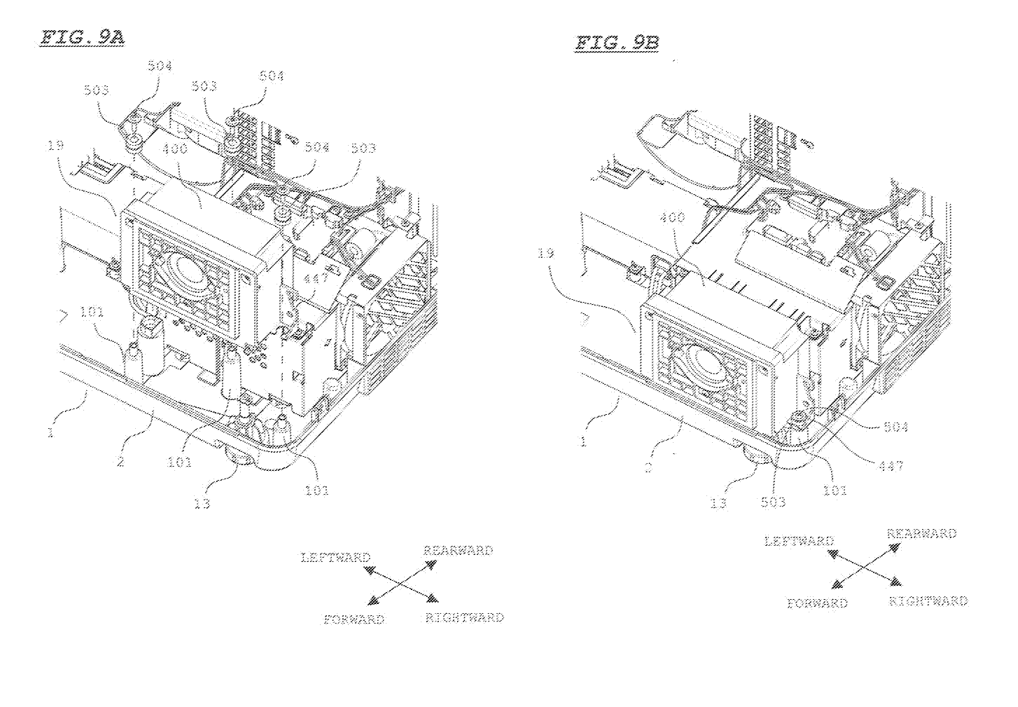

FIGS. 9A and 9B are diagrams for describing attachment of the speaker unit 19 to the main body cabinet 1. FIG. 9A is an exploded perspective view of main parts of the projector in which the speaker unit 19 is not yet attached to the main body cabinet 1. FIG. 9B is an exploded perspective view of main parts of the projector in which the speaker unit 19 is attached to the main body cabinet 1.

Three attachment bosses 101 corresponding to the three flange portions 447 of the speaker box 400 are formed on the bottom surface of the main body cabinet 1, that is, the bottom surface of the lower cabinet 2. FIGS. 9A and 9B illustrate only the flange portion 447 on the right side wall.

When attaching the speaker unit 19 to the main body cabinet 1, holes of the bushes 503 fitted onto the flange portions 447 are put on leading ends of the corresponding attachment bosses 101. Then, screws 509 are passed through the holes of the bushes and fastened at the attachment bosses 101. This allows the flange portions 947 to be fixed to the attachment bosses 101 via the bushes 503. Accordingly, the speaker unit 19 is fixed to the bottom surface of the main body cabinet 1.

On reception of an audio signal from the control circuit board 231, the speaker 300 is activated in accordance with the audio signal. Specifically, a cone of the speaker 300 vibrates in accordance with the audio signal to generate sound waves on the forward and rearward sides of the speaker 300. The sound waves generated forward of the speaker 300 are emitted forward of the speaker box 900 through the opening 411a. Meanwhile, the sound waves generated rearward of the speaker 300 are reflected on the inner wall surface of the inner box 430 and emitted from a duct 913. This realizes not-dull, clear sound quality with low pitch sounds emphasized.

When the speaker 300 is activated, the sound waves emitted rearward collide against the walls of the inner box 430 to thereby vibrate the inner box 930. However, the left side wall of the inner box 430 is reinforced inside by the first reinforcement ribs 432 and is reinforced outside by the second reinforcement ribs 442. The right side wall of the same is reinforced inside by the first reinforcement ribs 932 and is reinforced outside by the third reinforcement rib 493. The back wall of the same is reinforced inside by the first reinforcement ribs 432, and the bottom wall of the same is reinforced outside by the fifth reinforcement ribs 445. Accordingly, the right and left side walls, back wall, and bottom wall of the inner box 430 are reinforced and enhanced in stiffness properties by the reinforcement ribs 432, 492, 443, and 995, and thus the inner box 430 can be kept from vibration even with collision of sound waves.

In addition, since the space S1 is created between the left side wall of the inner box 930 and the left side wall of the outer box 490, even if the left side wall of the inner box 430 vibrates, the vibrations are less prone to be transferred to the left side wall of the outer box 440 due to buffering function of an air layer in the space S1. Further, since the left side wall of the outer box 440 is reinforced inside and enhanced in stiffness properties by the second reinforcement ribs 442, the left side wall of the outer box 990 is less prone to vibrate even if the vibrations are transferred from the inner box 930.

Likewise, even if the right side wall of the inner box 930 vibrates, the vibrations are less prone to be transferred to the right side wall of the outer box 490 due to buffering function of an air layer in the space S2. In addition, the right side wall of the outer box 440 is reinforced inside and enhanced in stiffness properties by the third reinforcement rib 443 and the fourth reinforcement ribs 444. Accordingly, the right side wall of the outer box 440 is less prone to vibrate as with the left side wall of the same.

Similarly, even if the bottom wall of the inner box 430 vibrates, the vibrations are less prone to be transferred to the bottom wall of the outer box 440 due to buffering function of an air layer in the space S3. In addition, the bottom wall of the outer box 440 is reinforced inside and enhanced in stiffness properties by the fifth reinforcement ribs 445. Accordingly, the bottom wall of the outer box 440 is less prone to vibrate, as with the right and left side walls of the same.

As is described above, in this embodiment, even if the inner box 430 is vibrated by the sound waves from the speaker 300, the right and left side walls and bottom wall of the outer box 440 are less prone to vibrate. Accordingly, it is possible to suppress transfer of vibrations to the bottom surface of the main body cabinet 1 via the flange portions 447 on the right and left side walls. In addition, it is also possible to prevent vibration of the bottom surface of the main body cabinet 1 with a narrow interval between the bottom walls, resulting from vibrations of the bottom walls. This makes it possible to prevent vibration of other component parts attached to the bottom surface of the main body cabinet 1 which results in generation of noise such as chatter.

In addition, the projection optical unit 17 is disposed on the left of the speaker unit 19 (see FIG. 3). In this embodiment, the left side wall of the outer box 440 is kept from vibration and thus no vibration is prone to be transferred to the projection optical unit 17 near the left side wall. This makes it possible to prevent that the projection optical unit 17 vibrates and shakes an image projected onto a screen.

In this embodiment, the speaker box 400 is made of a resin material, and no space is created between the back wall of the inner box 430 and the back wall of the outer box 440 because the space creation is difficult in the process of molding. However, the back wall of the outer box 440 is reinforced by the first reinforcement ribs 432 at a part in common with the back wall of the inner box 430 and reinforced by the second reinforcement ribs 442 to the fifth reinforcement ribs 445 at the remaining parts. This enhances the entire back wall of the outer box 440 in stiffness properties. Therefore, it is possible to suppress vibration of the back wall of the outer box 440 as much as possible on the whole even if the back wall of the outer box 440 in common with the back wall of the inner box 430 is subjected directly to vibration of the speaker 300. This makes it possible to minimize transfer of vibrations via the flange portion 447 formed on the back wall to the bottom surface of the main body cabinet 1.

In addition, in this embodiment, no space is also created between the top wall of the inner box 930 and the top wall of the outer box 440. Further, no reinforcement ribs are formed there. Accordingly, the top wall of the outer box 440 may vibrate more largely than the other walls. In this embodiment, however, no component parts exist above the speaker unit 19, and thus vibration of the top wall does not cause a major problem. In this manner, it is possible to prevent the speaker unit 19 from becoming unnecessarily large in size by making no space in unneeded positions.

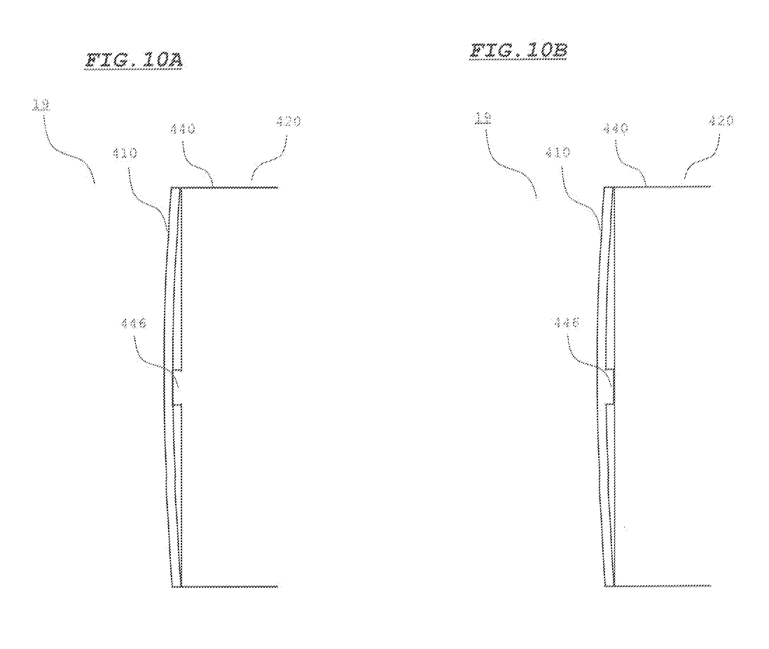

FIGS. 10A and 10B are diagrams showing schematically states of the front panel 410 attached to the rear box 420. FIG. 10A shows the speaker unit 19 of this embodiment, and FIG. 10B shows the speaker unit 19 of a modification example. In FIGS. 10A and 10B, the low rib 446 is described higher than in reality and the front panel 410 is depicted in a more extremely curved state than in reality, for convenience of illustration.

As shown in FIG. 10A, when the front panel 410 is attached to the outer box 940, an outer edge of the front panel 410 is pressed forward by the low rib 446 and thus is deformed in a slightly curved state with respect to the front end of the outer box 440. Due to a force of restoration from the deformation, the outer edge of the front panel 910 is pressed at a part between the two fixed corners against the outer box 490. This allows the outer edge of the front panel 410 to be less prone to vibrate even with vibrations transferred from the speaker 300 to the front panel 410.

Accordingly, in this embodiment, it is possible to suppress generation of noise on a junction plane between the front panel 410 and the outer box 440.

If the low rib 446 is not formed, the outer edge of the front panel 410 is less prone to be pressed at the part between the two fixed corners against the front end of the outer box 440. Accordingly, the outer edge of the front panel 410 is prone to vibrate and cause noise on the junction plane between the front panel 410 and the outer box 440.

As shown in FIG. 10B, the low rib 446 may be formed at the front panel 410, not at the outer box 440.

Although an embodiment of the present invention is as described above, the present invention is not limited to this embodiment. In addition, the embodiment of the present invention can further be modified in various manners besides the foregoing ones.

### Modification Example

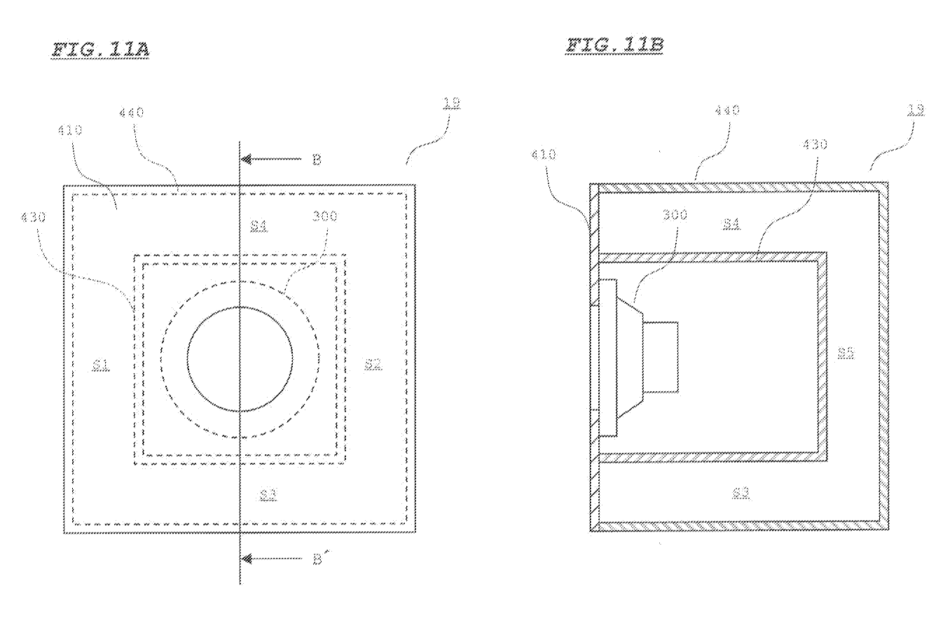

FIGS. 11A and 11B are diagrams showing a configuration of the speaker unit 19 in a modification example. FIG. 11A is a front view of the speaker unit 19, and FIG. 11B is a side view of FIG. 11A taken along a line B-B′.

In the speaker unit 19 of this modification example, the inner box 930 and the outer box 440 are formed as separate bodies. The boxes 930 and 440 are each fixed with screws or the like to the back surface of the front panel 410. In addition, the space S4 is created between the top wall of the inner box 430 and the top wall of the outer box 440. Further, the space S5 is created between the back wall of the inner box 430 and the back wall of the outer box 490.

This arrangement makes it possible to further suppress vibration of the top and back walls of the outer box 440 as compared with the foregoing embodiment.

As a matter of the course, only either of the two spaces S4 and S5, may be created. In addition, in this modification example, at least either the inner box 430 or the outer box 440 may be reinforced by reinforcement ribs.

### <Others>

In the foregoing embodiment, the space S1 is created between the right side walls of the inner box 430 and the outer box 940, the space S2 is created between the left side walls of the inner box 430 and the outer box 440, and the space S3 is created between the bottom walls of the inner box 430 and the outer box 440. However, vibrations of the outer box 440 are prone to be transferred to surrounding component parts in particular via the flange portions 447. Accordingly, if the flange portions 447 are formed on the right and left side walls of the speaker box 400 as in the foregoing embodiment, only the spaces S1 and S2 may be created between the right side walls and between the left side walls of the inner box 430 and the outer box 440. This allows the speaker unit 19 to be made smaller in size as much as possible.

In addition, in the foregoing embodiment, both the inner box 430 and the outer box 440 are reinforced by the reinforcement ribs 432, and 442 to 445. Alternatively, only the inner box 430 or only the outer box 440 may be reinforced by reinforcement ribs depending on the strength of vibrations transferred from the speaker 300.

Further, the speaker device of the present invention can be applied to electrical devices other than projectors, such as personal computers.

Besides, the embodiment of the present invention can be modified in various manners as appropriate within the scope of a technical idea recited in the claims.

What is claimed is:

1. A projection display device, comprising:
a light source;
a light modulation portion which modulates light from the light source in accordance with an image signal;
a projection portion which projects the light modulated by the light modulation portion onto a projection plane;
a speaker device which outputs a sound in accordance with an audio signal; and
a main body cabinet in which the light source, the light modulation portion, the projection portion, and the speaker device are disposed, wherein
the speaker device includes a speaker and a speaker box storing the speaker,
the speaker box includes:
a front panel to which the speaker is attached;
an inner box which covers the speaker attached to the front panel from behind; and
an outer box which covers the periphery of the inner box and is attached to the main body cabinet, and
a space is created between the inner box and the outer box.

2. A projection display device according to claim 1, wherein
the outer box is provided with an attachment portion to be attached to the main body cabinet, and
the space is created between a wall of the outer box with the attachment portion and a wall of the inner box opposed to the wall of the outer box.

3. A projection display device according to claim 1, wherein
the space is created between a wall of the outer box opposed to an inner side surface of the main body cabinet to which the speaker device is attached and a wall of the inner box opposed to the wall of the outer box.

4. A projection display device according to claim 1, wherein
the speaker device is disposed adjacent to the projection portion, and
the space is created between a wall of the outer box on the projection portion side and a wall of the inner box opposed to the wall of the outer box.

5. A projection display device according to claim 1, wherein
the wall of the inner box is reinforced by a rib.

6. A projection display device according to claim 1, wherein
the wall of the outer box is reinforced by a rib.

7. A projection display device according to claim 1, wherein
the front panel is fixed to a front portion of the outer box at least at two fixing points in an outer edge of the front panel, and
a depressing portion which depresses the front panel forward is formed between the fixing points.

8. A speaker device, comprising:
a speaker; and
a speaker box storing the speaker, wherein
the speaker box includes:
a front panel to which the speaker is attached;
an inner box which covers the speaker attached to the front panel from behind; and
an outer box which covers the periphery of the inner box, and
a space is created between the inner box and the outer box.

9. A speaker device according to claim 8, wherein
the outer box is provided with an attachment portion to be attached to the main body cabinet in which the speaker device is disposed, and
the space is created between a wall of the outer box with the attachment portion and a wall of the inner box opposed to the wall of the outer box.

10. A speaker device according to claim 9, wherein
the space is created between a wall of the outer box opposed to an inner side surface of the main body cabinet to which the speaker device is attached and a wall of the inner box opposed to the wall of the outer box.

11. A speaker device according to claim 8, wherein
the wall of the inner box is reinforced by a rib.

12. A speaker device according to claim 8, wherein
the wall of the outer box is reinforced by a rib.

13. A speaker device according to claim 8, wherein
the front panel is fixed to a front portion of the outer box at least at two fixing points in an outer edge of the front panel, and
a depressing portion which depresses the front panel forward is formed between the fixing points.
